(19) United States
(12) Patent Application Publication
(10) Pub. No.: US 2008/0241547 A1
(43) Pub. Date: Oct. 2, 2008

(54) METHODS OF LASER SURFACE MODIFICATION OF CERAMIC PACKAGES FOR UNDERFILL SPREAD CONTROL AND STRUCTURES FORMED THEREBY

(76) Inventor: Ravi K. Nalla, Chandler, AZ (US)

Correspondence Address: INTEL CORPORATION;c/o INTELLEVATE, LLC, P.O. BOX 52050, MINNEAPOLIS, MN, 55402, US

(21) Appl. No.: 11/691,390

(22) Filed: Mar. 26, 2007

(51) Int. Cl. B32B 17/00

(52) U.S. Cl. 428/410; 438/474

(57) ABSTRACT

Methods and associated structures of forming a microelectronic device are described. Those methods may include heating a portion of a ceramic substrate adjacent to a C4 area with a defocused laser, wherein a smooth region of the substrate is created, and applying an underfill material to the C4 area, wherein the underfill material does not extend past the smooth region.

### BACKGROUND OF THE INVENTION

Ceramic packages, particularly with multiple and/or large-dies, as in the case of server products, may require a large amount of underfill material to be dispensed under the die area after die-substrate C4 assembly. It is desirable to impede the flow of this material outside the die shadow area to minimize the keep-out zone where no components can be placed. This will avoid using real estate on the substrate that could be utilized for the placement of other components such as die side capacitors, for example.

### BRIEF DESCRIPTION OF THE DRAWINGS

While the specification concludes with claims particularly pointing out and distinctly claiming that which is regarded as the present invention, the advantages of this invention can be more readily ascertained from the following description of the invention when read in conjunction with the accompanying drawings in which:

FIGS. 1a-1g represent structures according to an embodiment of the present invention.

### DETAILED DESCRIPTION OF THE PRESENT INVENTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein, in connection with one embodiment, may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

Methods and associated structures of forming a microelectronic structure are described. Those methods may include heating a portion of a rough substrate adjacent to a C4 area with a defocused laser, wherein a smooth region of the substrate is created, and applying an underfill material to the C4 area, wherein the underfill material does not extend past the smooth region. Methods of the present invention increase the real estate available outside the C4 area by limiting the spread of the underfill material for microelectronic devices fabricated according to the embodiments of the present invention.

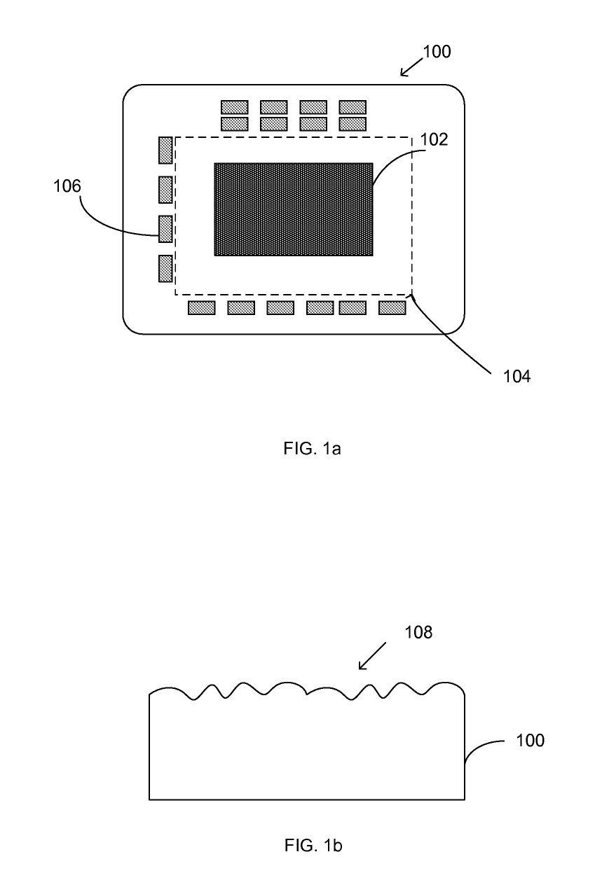

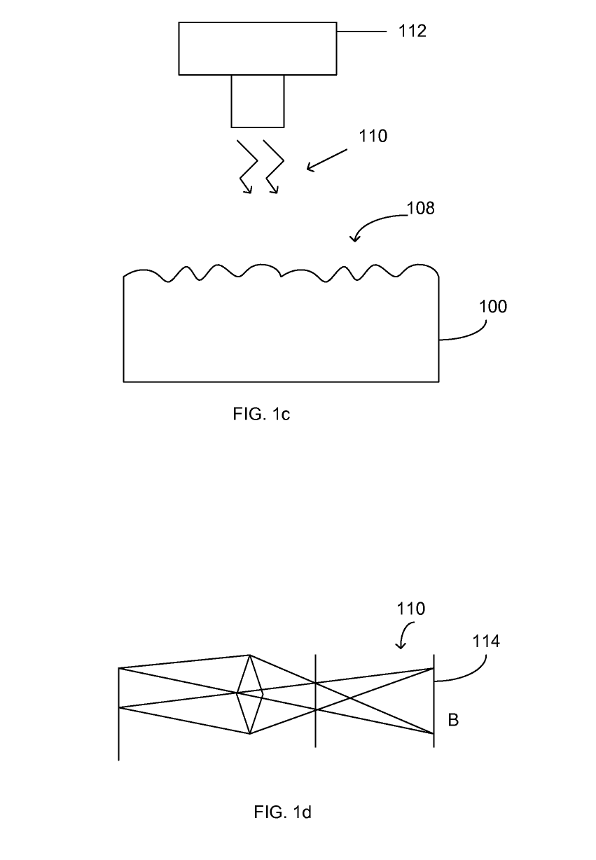

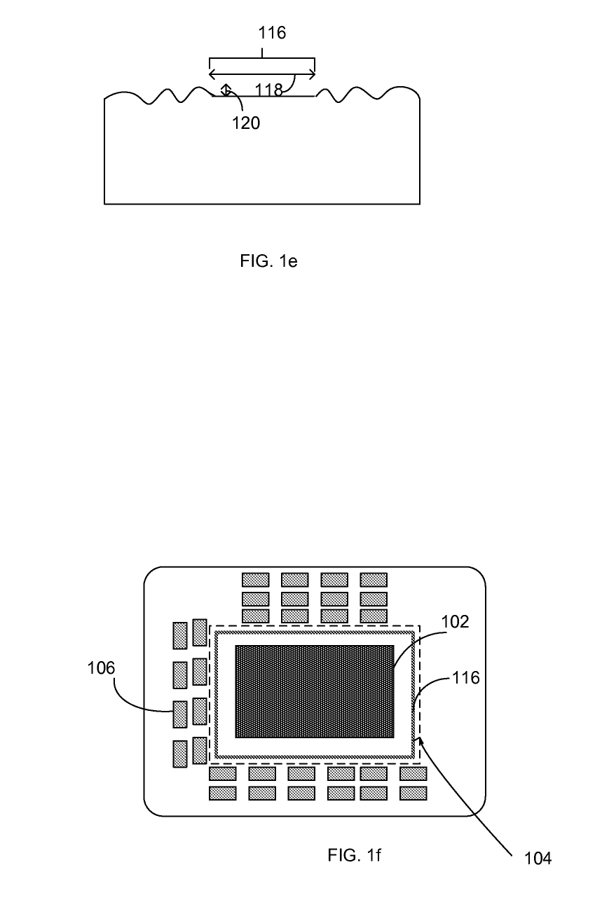

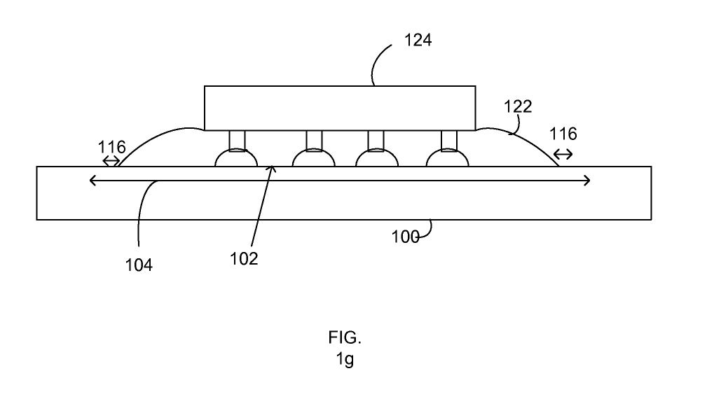

FIGS. 1a-1g illustrate embodiments of methods of fabricating a package substrate, such as modifying a package surface to impede underfill spread on microelectronic packages. FIG. 1a illustrates a top view of a portion of a substrate 100. In one embodiment, the substrate 100 may comprise a portion of a ceramic package substrate, but other types of package substrates, such as but not limited to organic packages, may be utilized according to the various embodiments of the present invention. The substrate 100 may further comprise a C4 area 102, which may comprise an array of solder bumps in some embodiments, as is known in the art.

The solder bumps may serve as connections to at least one die, such as a silicon die, which may be attached to the substrate 100 during subsequent processing steps, in some embodiments. The substrate 100 may also comprise a keep out zone 104 surrounding the C4 area 102, outside which other components 106 such as but not limited to die side capacitors, inductors, voltage regulators etc. may be located. In one embodiment, the substrate 100 may comprise a glass coating (not shown) disposed on the ceramic substrate 100.

The substrate 100 surrounding and/or adjacent to the C4 area 102 may comprise a roughness 108 (FIG. 1b, cross sectional view) from ceramic substrate processing. A defocused laser beam 110 may be utilized to smooth out a portion of the roughness 108 of the substrate 100 (FIG. 1c). In one embodiment, a portion of the substrate 100 surrounding and/or adjacent to the C4 area 102 may be smoothed, but the portion of the substrate that may be smoothed by the defocused beam will depend upon the particular application. The defocused beam 110 may be generated from a light source 112, which may comprise any type of laser light source suitable for generating a defocused beam. In one embodiment, the defocused beam may comprise a Fresnel diffraction beam, as depicted in FIG. 1d. In one embodiment, the defocused beam 110 may project in a plane B 114, for example. In one embodiment, the defocused beam 110 may comprise a Fresnel diffraction beam.

Using the defocused beam 110 to heat and smooth the rough portion of the substrate 100 leads to a lower, much more uniform energy distribution on the substrate 100. This defocused beam 110 can be utilized to surface treat the substrate 100 more homogeneously, while substantially avoiding vaporization and plasma formation which may lead to substrate ablation, as may occur when forming an undesirable trench around the C4 area 102. Such trenches are undesirable as they are potential initiator sites for cracks and hence, are a concern from reliability perspective.

By heating a portion of the surface of the substrate 100, localized melting may occur uniformly across a footprint of the defocused beam 110 on the substrate 100, and subsequent solidification will produce a smooth region 116 (FIG. 1e) without actual trenching of the substrate 100. Such a smooth region 116 may effectively impede the flow of an underfill material that may be applied between the substrate 100 and a die that may have been attached during a previous die attach process.

In one embodiment, the smooth region 116 may comprise a width 118 and a height 120. In some embodiments, the width 118 may comprise a range of about 5 microns to about 5 mm. In one embodiment, the height 118 may comprise a range of about 1-2 microns, in other embodiments, the height 120 may comprise a range of about 5 microns or less. In one embodiment, the smooth region 116 may surround the C4 area 102 (FIG. 1f, top view). In this manner, the smooth region 116 may impede the flow of underfill material that may be subsequently applied between the substrate 100 and a die, after the die attach process, for example. In one embodiment, the smooth region 116 may prevent the the underfill material from substantially flowing outside of the keep out zone 104.

FIG. 1g depicts a cross-sectional view of an underfill material 122 disposed between the substrate 100 and a die 124. The smooth region 116 surrounding the C4 area 102 may substantially prevent the underfill 122 from flowing past the smooth region 116. Thus, the smooth region 116 enables reduction of the keep-out zone 104 and the maximization of real estate on the substrate 100 outside of the keep-out zone 104 that can be used for attaching other components, and also improves the reliability of the substrate 100, since the smooth region 116 does not contribute to stress/cracking related failures, as may be present when other underfill flow inhibitor structures may be present, such as when a trench may be employed to impede underfill flow.

Thus, embodiments of the present invention include may provide methods of performing surface modification of package substrates that impede underfill spread on the substrate. Impeding the flow of underfill material outside of the die shadow area may avoid using real estate on the substrate that could be utilized for placing other components (e.g., die side capacitors, inductors, voltage regulators etc.) on the substrate. Embodiments of the present invention enable improved substrate mechanical properties and reliability over trenched structures to prevent underfill flow.

Although the foregoing description has specified certain steps and materials that may be used in the method of the present invention, those skilled in the art will appreciate that many modifications and substitutions may be made. Accordingly, it is intended that all such modifications, alterations, substitutions and additions be considered to fall within the spirit and scope of the invention as defined by the appended claims. In addition, it is appreciated that certain aspects of microelectronic devices are well known in the art. Therefore, it is appreciated that the Figures provided herein illustrate only portions of an exemplary microelectronic structure that pertains to the practice of the present invention. Thus, the present invention is not limited to the structures described herein.

What is claimed is:

1. A method comprising:
heating a portion of a substrate adjacent to a C4 area with a defocused laser, wherein a smooth region of the substrate is created;
applying an underfill material to the C4 area, wherein the underfill material does not extend past the smooth region.

2. The method of claim 1 wherein the underfill material does not extend past the smooth region comprises wherein the smooth region impedes the flow of the underfill material, wherein the underfill material does not substantially flow outside of a die shadow area.

3. The method of claim 1 further comprising wherein the smooth region does not comprise a trench.

4. The method of claim 1 wherein the C4 area is located on a ceramic package.

5. The method of claim 1 wherein the substrate comprises a glass coating.

6. The method of claim 1 wherein the defocused beam comprises a Fresnel diffraction beam that does not substantially vaporize a portion of the substrate and does not substantially create a plasma at the surface of the substrate.

7. The method of claim 1 wherein heating the portion of the substrate comprises heating the portion of the substrate with a laser.

8. The method of claim 1 further comprising wherein the smooth region comprises a width of about 5 microns to about 5 millimeters.

9. The method of claim 1 further comprising wherein the smooth region comprises a height of under about 5 microns.

10. A structure comprising:
a smooth region of a substrate adjacent to a C4 area,
wherein an underfill material disposed between the C4 area and a die does not extend past the smooth region.

11. The structure of claim 10 wherein the underfill material is not substantially located outside of the region defined by laser surface modification.

12. The structure of claim 10 wherein the smooth region comprises a height below about 5 microns.

13. The structure of claim 10 wherein the substrate further comprises a ceramic substrate.

14. The structure of claim 10 wherein the smooth region comprises a width of about 5 microns to about 5 mm.

15. The structure of claim 10 wherein the smooth region surrounds the C4 region.
